(19) United States
(12) Patent Application Publication
(10) Pub. No.: US 2008/0183923 A1
(43) Pub. Date: Jul. 31, 2008

(54) Determining an Optimal Data Transfer Rate Via a Transfer Medium

(76) Inventor: Josef Forster, Munchen (DE)

Correspondence Address: BELL, BOYD & LLOYD, LLP, P.O. BOX 1135, CHICAGO, IL, 60690, US

(21) Appl. No.: 11/884,064

(22) PCT Filed: Jan. 24, 2006
(86) PCT No.: PCT/EP06/50387

§ 371 Date: Aug. 9, 2007

(30) Foreign Application Priority Data
Feb. 15, 2005 (DE) 10 2005 006 890.1

(51) Int. Cl. G06F 13/14

(52) U.S. Cl. 710/60

(57) ABSTRACT

Sequences that respectively comprise different data are transmitted via a transfer medium, the transfer quality being detected in accordance with the transmitted sequences. Accordingly, the sequences to be transmitted are assigned to several chronologically sequential stages, the sequences that are assigned to one stage having a pre-definable interval in terms of the data transfer rate. The following steps are executed cyclically: a) transmission of at least part of the sequences that are assigned to the first stage and selection of an interval that is situated between two transmitted sequences, in accordance with the determined transfer quality; b) transmission of at least part of the sequences that lie in the selected interval and that are assigned to the subsequent stage. Thus an optimal data transfer rate can be accurately determined for the transmission of information via the transfer medium.

### CROSS REFERENCE TO RELATED APPLICATIONS

This application is the US National Stage of International Application No. PCT/EP2006/050387, filed Jan. 24, 2006 and claims the benefit thereof. The International Application claims the benefits of German application No. 102005006890.1 DE filed Feb. 15, 2005, both of the applications are incorporated by reference herein in their entirety.

### FIELD OF INVENTION

The present invention relates to determining an optimal data transfer rate via a transfer medium.

### BACKGROUND OF INVENTION

In current data transmission methods, such as the SHDSL (“single pair high bit rate digital subscriber line”) data transmission method, the optimal data transfer rate is defined when a connection is set up for communication between the subscribers or between their communication devices. In such cases one of the actions undertaken is what is known as a training phase (“test probing”—line test) in which different baud rates or bit rates are tested. Baud rate is taken here to mean the number of characters or symbols per unit of time.

During this training phase a specific previously negotiated number of test sequences with different baud rates for example is sent out by a communication device (e.g. modem) assigned to a subscriber and these sequences are received by a further communication device connected to the communication device via the transmission medium.

The test sequences involve predetermined test patterns which are known to the communication devices. The respective transmission quality or signal quality is subsequently determined on the receiving communication device side for each test sequence received. The received test pattern is compared with the known original pattern for this purpose for example. After conclusion of the training phase the connection can be continued with the data transfer rate delivering the optimal transmission quality determined within the framework of the training phase.

### SUMMARY OF INVENTION

Since with most data transmission methods however a relatively high number of possible data transfer rates can be used but the training phase is to be kept relatively short, i.e. the number of test sequences able to be sent out is limited, all possible data transfer rates are frequently no able to be tested with test sequences provided specifically for the purpose. The signal quality for non-tested data transfer rates is thus determined by interpolation. These data transfer rates determined within the framework of interpolation are not precise however, which on the one hand can result in transmission errors in the subsequent information transfer and on the other hand can result in a non-optimal utilization of the transmission link.

An object of the invention is to improve the method for determining an optimal data transfer rate. This object is achieved, using a method in accordance with the features of the independent claims.

With the inventive method for determining the optimal data transfer rate via a transfer medium sequences featuring different data transfer rates are transmitted via the transfer medium and the transmission quality is determined as a function of the respective sequences transferred. The important aspect of the invention consists of the sequences to be transmitted being assigned to a number of chronologically sequential stages. Furthermore the sequences assigned to a stage have a predeterminable interval as regards the data transfer rate. The following steps are performed in the method:

a) Transfer of at least one part of the sequences assigned to a stage and selection of a time interval arranged between two transferred sequences as a function of the transmission quality determined, and

b) Transfer of at least of one part of the sequences lying in the selected interval and assigned to the subsequent stage.

The major advantage of the invention consists of the assignment of the test sequences to a number of chronologically sequential stages allowing a more precise determination of the optimal data transfer rate for information transfer.

Advantageously the above-mentioned steps a) and b) can only be performed cyclically a number of times.

The sequences can furthermore advantageously be transferred with different data transmission methods, i.e. different modulation methods and/or different transmit power for example. This enables the optimization of the data transfer rate to be further improved.

The-above mentioned steps can also be executed in accordance with an advantageous development until such time as a maximum number of test sequences has been transferred or until a predetermined number of steps have been performed.

In accordance with an additional advantageous development of the inventive method, the number of stages can be selected so that two adjacent test sequences in the last stage have the smallest possible interval as regards their data transfer rate. Advantageously this smallest possible interval also has the value one. These advantageous developments enable the accuracy in the determination of the optimal data transfer rate for transmission to be increased.

In accordance with a further advantageous development of the inventive method the intervals between the test sequences assigned to a stage become smaller in the chronologically sequential stages. Advantageously the intervals between the test sequences of the same stage have approximately the same value. The major feature of these expansions is a more rapid reduction of the intervals between adjacent test sequences with each successive stage, which means that the precise determination of the optimal data transfer rate is achieved more quickly.

Further advantageous embodiments of the inventive method as well as a communication device and a communication system for determining the optimal data transfer rate via a transfer medium are to be found in the dependent claims.

### BRIEF DESCRIPTION OF THE DRAWINGS

The invention is explained below with reference to a number of drawings. The figures show

FIG. 1 a schematic diagram of the timing of the training phase undertaken between two communication units within the framework of connection setup in accordance with the prior art,

FIG. 2 a schematic diagram of the typical determination of the optimal transmission rate within the context of the training phase as depicted in FIG. 1,

FIG. 3 a schematic diagram of the timing of the training phase within the context of the inventive method, and

FIG. 4 a more detailed schematic diagram of the typical determination of the optimal transmission rate within the context of inventive method.

### DETAILED DESCRIPTION OF INVENTION

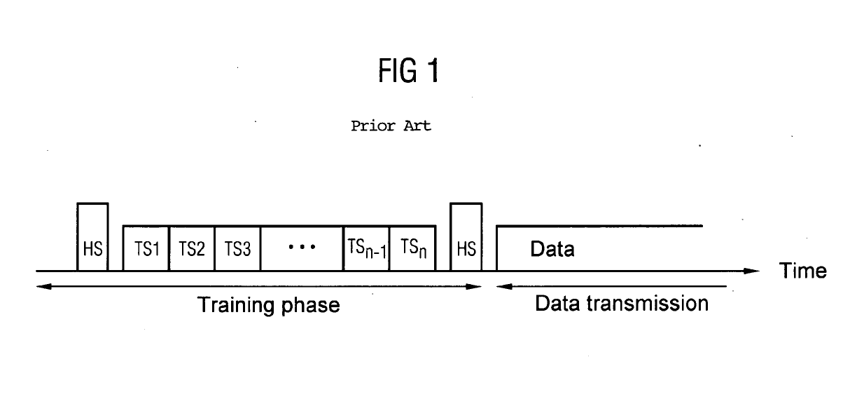

FIG. 1 shows a schematic diagram of the known timing sequence during connection setup in a telecommunication arrangement to be arranged in accordance with the prior art, which in this exemplary embodiment is designed in accordance with the SHDSL method. This example involves comparing the quality of the test sequence when different baud rates are used.

During the test phase, for determining the optimal baud rate on connection setup n predetermined test sequences (TS1, . . . , TSn) with different, increasing baud rates in each case are generally transmitted by means of a handshake method from a communication device to a further communication device, with the quality of the received test sequences being recorded and determined. Handshake method means in general that he parameters for the data transfer are negotiated and readiness to send or readiness to receive is indicated between the two communication devices using what are referred to as mutual handshake signals (HS).

It is known that the quality of the receive signals is recorded by the receiver using for example a comparison of the received test pattern with the predetermined original pattern. The results of these quality tests are subsequently communicated to the sending communication device.

After execution of the test phase the optimal baud rate is determined by the transmitter based on the test results for the subsequent transmission of the payload data. To this end the highest baud rate is selected for which a sufficient quality of the information to be transferred can still be achieved. The transmission of the actual payload data (data) is then started.

Since for example in the SHDSL method a maximum of 10 test sequences are available for the training phase, compared to up to 67 different baud rates which can be used for information transfer, the signal qualities can disadvantageously not be exactly tested for all baud rates. For baud rates not tested the signal quality can thus only be determined through interpolation. These baud rates determined within the framework of interpolation are however, as already explained, imprecise, which, if the received quality is too low, results in transmission errors in the subsequent information transfer and, if the quality is too high, results in the resources of the transmission link not being utilized in the optimal way.

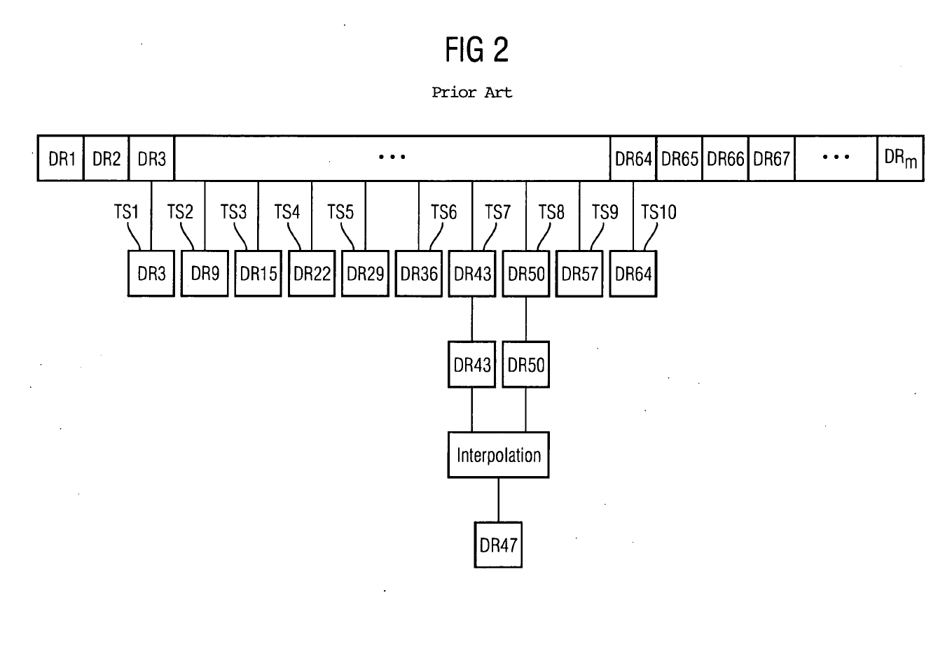

FIG. 2 shows a typical sequence of m generally possible baud rates (DR1, . . . , DRm). For communication in accordance with the SHDSL data transmission method according to the known prior art, test sequences (TS1, . . . , TSn) representing a specific baud rate (DR1, . . . , DRm) are transferred in each case during the training phase. The typical following assignment is assumed: n=10 as well as m=67. To determine the optimal baud rate the test sequences TS1 to TS10 are assigned to the baud rates DR3, DR9, DR15, DR22, DR29, DR36, DR43, DR50, DR57 and DR64. In the transmission of these ten test sequences (TS1, . . . , TS10) their signal quality is recorded and determined in the receiver. If the signal quality in such a case for example is still higher than the required minimum signal quality at a baud rate DR43 having a lower value but, but lower than the stated minimum quality at a baud rate DR50 having a higher value however, the exact value of the optimal baud rate for information transmission must be determined by interpolation of the values at DR43 and DR50 (in this case DR47 for example). The optimal baud rate is thus only approximated but not precisely verified.

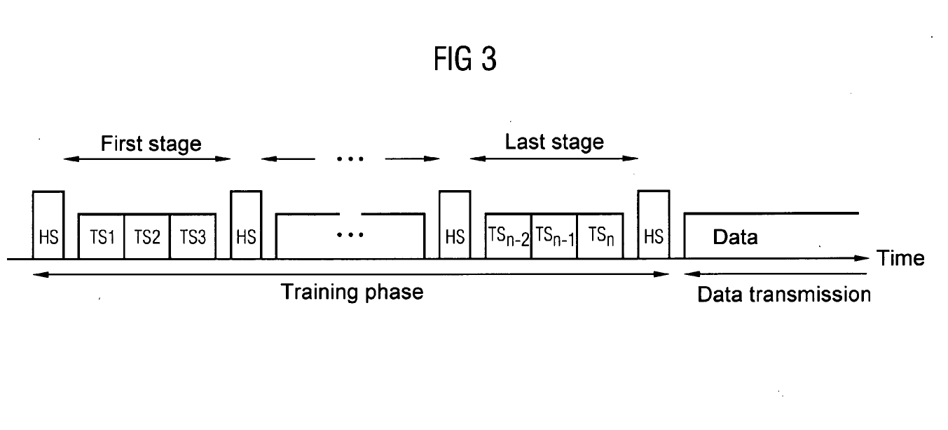

FIG. 3 shows a schematic diagram of the timing of the training phase between two communication devices (not shown) connected to each other via a transmission medium within the framework of the inventive method. In this case a communication device can be embodied for example as a modem assigned to a subscriber, the corresponding communication device can for example be assigned to a central switching device. In the exemplary embodiment illustrated by FIG. 3 information is transmitted within the framework of the SHDSL transmission method, with once again 67 different baud rates able to be used for information transfer, but within the framework of the training phase, a maximum of ten test sequences (TS1, . . . , TS10) being able to be sent out.

During connection setup the transmission parameters are defined with the aid of a handshake method within the framework of the training phase. In accordance with the invention, the test sequences (TS1, . . . , TSn) used here however are assigned to a number of stages (stage1, stage2, stage3). In the first stage (stage1) for example only three test sequences (TS1, TS2, TS3) are transmitted, i.e. sent out by the modem and received in the switching device or vice versa. After the signal qualities of the three received test sequences (TS1, TS2, TS3) have been recorded, the recorded result or test result is transmitted to the send side using a further handshake signal (HS). Depending on the transmitted test results, in further stages (stage2, stage3) a number of further test sequences (TS4, TS5, TS6 or TSn-2, TSn-1, TSn) are transferred and the respective signal qualities recorded.

The transmission quality or signal quality can be recorded in different ways as a function of the transferred sequences or test sequences (TS, . . . , TSn) respectively. For example the amplitude and/or the bit error rate of the received signals can be recorded, usually however the signal-to-noise ratio (SNR) is determined by a comparison of the known original test pattern with the received sequence (TS, . . . , TSn).

In this case, for each received sequence (TS, . . . , TSn), its amplitude or signal-to-noise ratio respectively is recorded or measured in the receiving communication device and information representing the recording result is transmitted for example within the framework of the handshake method to the communication device sending out the sequence.

Alternatively the amplitude or signal-to-noise ratio of a number of received sequences (TS, . . . , TSn) are recorded and subsequently information representing the summary of the recording results is transmitted to the communication device sending out the sequence.

The transmission quality can be determined or derived from the recording results (e.g. values for signal-to-noise ratio) transferred to the communication device sending out the sequence.

Alternatively the transmission quality can also be determined at the receiving communication device from the recording results (e.g. values for signal-to-noise ratio) and information representing the transmission quality or service control information derived from the transmission quality can be transferred to the sending communication device.

The sending out of further test sequences (TS, . . . , TSn) is controlled as a function of the transmission quality.

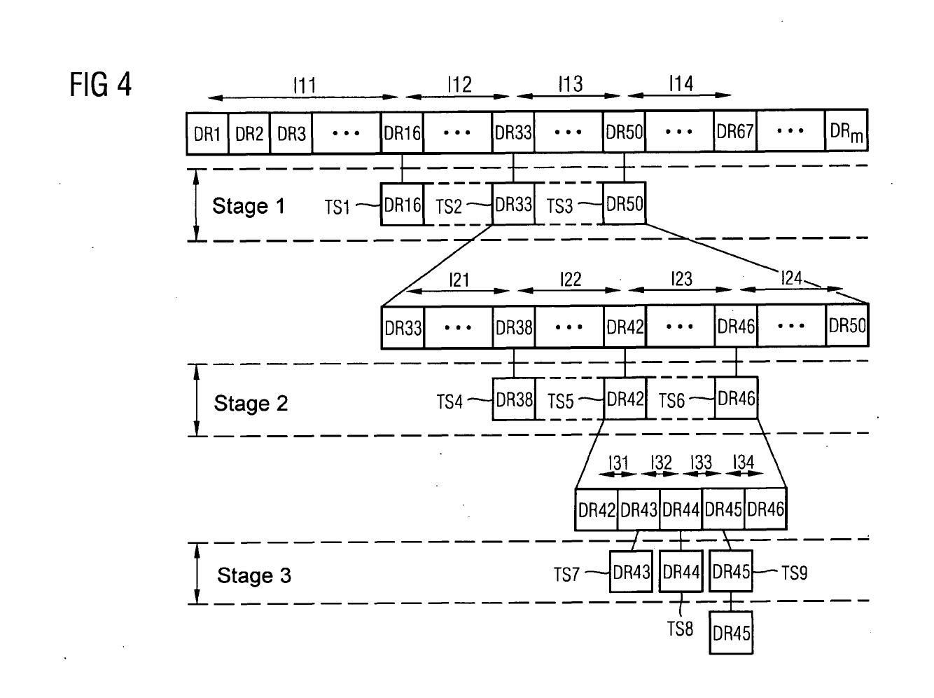

The selection of the respective baud rates (DR1, . . . , DRm) for the individual test sequences (TS, . . . , TSn) and the inventive assigrnent of the test sequences (TS, . . . , TSn) to the individual stages (stage1, stage2, stage3) is shown schematically in FIG. 4. In this case n=9 is taken as the number of test sequences (TS, . . . , TSn) and m=67 for the number of baud rates usable for information transfer. For example test sequences (TS1, TS2, TS3) are tested in the first stage with baud rates DR16, DR33 and DR50. The range of all baud rates possible in this example (DR1, . . . , DR67) is thus subdivided into intervals as equal as possible in size (I11, I12, I13, I14). On the basis of the signal qualities of the first three test sequences (TS1, TS2, TS3) of the first stage (stage1) the interval (I11, I12, I13, I14) in which the optimal baud rate for the connection must be situated is subsequently determined: In this example the signal quality at baud rate DR33 is still greater than the required minimum signal quality, at the higher baud rate DR50 the quality is already lower than the minimum quality. Further testing, i.e. the test sequences (TS4, . . . , TS9) to be sent out within the framework of the subsequent stages (stage2, stage3) is concentrated on the interval (I13) between baud rates DR33 and DR50.

In the second stage (stage2) of the inventive method the signal qualities of the test sequences TS4, TS5 and TS6 are then tested with the corresponding baud rates DR38, DR42 and DR46. Here too the interval (I13) determined beforehand or the baud rates (DR33 to DR50) assigned to this interval (I13) are subdivided into subintervals (I21, I22, I23, I24) of approximately the same size. The test results of the second stage (stage2) are transmitted using handshake signals and the new subinterval (I23) in which the optimal baud rate must be situated is again determined. As can be seen from FIG. 4, the new subinterval (I23) is arranged between the baud rates DR42 and DR46.

In a concluding third stage (stage3) the signal qualities of the test sequences TS7, TS8 and TS9 are detected and determined with the corresponding baud rates DR43, DR44 or DR45 and the optimal baud rate for the current connection (here: DR45) is finally defined as a function of the determination result. The recorded signal qualities are for example investigated as to the baud rate (here: DR45) as from which the signal quality of a test sequence (TS7, TS8, TS9) sent out within the framework of the third stage (stage3) falls below the required minimum quality for the first time. The payload data transmission following on from the training phase is subsequently undertaken at this baud rate (here:DR45) defined during the training phase.

Furthermore it is possible, within the framework of the inventive method (not explained in any greater detail in this exemplary embodiment) to create test sequences using different modulation methods (such as PAM16 or PAM32 or also PPM or QAM) and to transmit them using different transmit powers. It would likewise be possible to provide test sequences with further different transmission parameters for the execution of the inventive method,

Through the more precise determination of an optimal data transfer rate made possible here with the inventive method, up to 7 dB can be gained by comparison with current methods for determining the data transfer rate in information transfer or data transfer. For SHDSL systems for example this corresponds to an increase in range of 0.5 km.

1.-21. (canceled)

22. A method for determining an optimal data transfer rate via a transfer medium, comprising:
a.) providing a plurality of sequences having different data transfer rates;
b.) distributing the sequences amongst a plurality of chronologically sequential stages such that the sequences assigned to each stage have a pre-determinable interval in respect to the data transfer rate;
c.) transferring at least of a portion of the sequences assigned to a stage and selecting an interval arranged between two transferred sequences as a function of a transmission quality; and
d.) transferring at least a part of the sequences lying in the selected interval and assigned to a subsequent stage.

23. The method as claimed in claim 22, wherein steps c and d are repeated.

24. The method as claimed in claim 22, wherein the sequences are transferred at least partly with different data transmission methods.

25. The method as claimed in claim 24, wherein the sequences are created at least partly with different modulation methods or transferred with different transmit powers.

26. The method as claimed in one of the claim 22, wherein steps c and d are repeated in a cycle until a pre-determinable maximum number of sequences have been transferred.

27. The method as claimed in one of the claim 22, wherein steps c and d are repeated in a cycle for a specified number of stages.

28. The method as claimed in one of the claim 22, wherein a number of the stages is determined such that the last stage two adjacent sequences are as close to each other as possible in respect of their data transfer rate, the method further comprising determining an optimal transmission rate being by interpolation of the selected adjacent sequences.

29. The method as claimed in one of the claim 22, wherein a number of the stages is determined such that the interval between two adjacent sequences in the last stage has the value one in respect of the data transfer rate.

30. The method as claimed in one of the claim 22, wherein the interval between the sequences assigned to a stage becomes smaller in the chronologically subsequent stage in respect of the data transfer rate.

31. The method as claimed in one of the claim 22, wherein the intervals between two sequences adjacent to each other and assigned to the same stage have approximately the same value.

32. The method as claimed in one of the claim 22, wherein the transfer medium is embodied as a wireless transfer medium or as a wired transfer medium or as an optical transfer medium.

33. The method as claimed in one of the claim 22, wherein the transmission quality is recorded with at least one indicia of a received sequence, the indicia selected from the group consisting of amplitude, bit error rate, and signal-to-noise ratio.

34. The method as claimed in one of the claim 22, wherein the optimal data transfer rate is determined within the framework of an xDSL transmission method.

35. A communication device for determining the highest possible data transfer rate via a transmission medium able to be connected to said device, comprising:
a transmission unit transferring a plurality of sequences having different data transfer rates via the transfer medium;
a recording unit for recording information representing a transmission quality as a function of the transferred sequences; and
an assignment unit assigning the sequences to a number of chronologically sequential stages with the sequences assigned to one stage having a pre-determinable interval in respect of the data transfer rate,
wherein the transfer unit and the recording unit embodied such that:
a.) at least a portion of the sequences assigned to a stage are transferred
b.) an interval arranged between two transferred sequences is selected as a function of the transmission quality determined, and
c.) at least a portion of the sequences in the selected interval and assigned to a subsequent stage are transferred.

36. The communication device as claimed in claim 35, wherein the transfer unit and the recording unit embodied to repeat a, b and c.

37. The communication device as claimed in claim 36, wherein a, b and c are repeated until a maximum number of sequences are transferred.

38. The communication device as claimed in claim 36, wherein a, b and c are repeated until a specified number of stages are transferred.

39. The communication device as claimed in claim 36, wherein the transfer unit, the assignment unit and the recording unit are embodied such that:
a number of stages is determined such that in the last stage, two adjacent sequences have the smallest possible interval in respect of the data transfer rate, and an optimal transmission rate is determined by interpolation of the selected adjacent sequences

40. The communication device as claimed in claim 39, wherein the transfer unit, the assignment unit and the recording unit are embodied such a number of stages is selected such that in the last stage the interval between two adjacent sequences has the value of one in respect of the data transfer rate.

41. The communication device as claimed in claim 40, wherein the communication device is embodied as decentralized communication device assigned to the subscriber-side or is arranged as a central switching device.

42. A communication arrangement for determining an optimal data transfer rate via a transfer medium, comprising:
a transfer unit for transferring a plurality of sequences having different data transmission rates via the transfer medium
a recording unit for recording the transmission quality as a function of the transferred sequences; and
an assignment unit by which the sequences to be transferred are assigned to a number of chronologically sequential stages, with sequences assigned to a same stage, have a pre-determinable interval in respect of the data transfer rate, and
the transfer unit and the recording unit embodied such that:
a) at least a part of the sequences assigned to a stage are transferred and an interval arranged between two transferred sequences is selected as a function of the transmission quality determined, and
b) at least a part of the sequences lying in the selected interval and assigned to the subsequent stage are transferred.
